(19) United States
(12) Patent Application Publication
(10) Pub. No.: US 2005/0027041 A1
(43) Pub. Date: Feb. 3, 2005

(54) Paste including inorganic powder, method for producing the same and method for producing plasma display panel member

(75) Inventors: Kazutaka Kusano, Otsu-shi (JP); Akio Kakimoto, Kusatsu-shi (JP); Yuichiro Iguchi, Otsu-shi (JP)

Correspondence Address: Barry E. Bretschneider;Morrison & Foerster LLP, Suite 300, 1650 Tysons Boulevard, McLean, VA, 22102, US

(73) Assignee: Toray Industries, Inc., Tokyo (JP)

(21) Appl. No.: 10/631,851

(22) Filed: Aug. 1, 2003

(51) Int. Cl. C08J 3/20

(52) U.S. Cl. 523/324

(57) ABSTRACT

The present invention relates to a method for producing a paste including an inorganic powder in which a paste including an inorganic powder is dispersed by a disperser having rollers provided in a cylindrical vessel. The present invention can provide a paste including an inorganic powder containing small amounts of foreign substances and having excellent dispersibility by a treatment for a short time.

### BACKGROUND OF THE INVENTION

1. Field of the Invention

The present invention relates to a paste including an inorganic power suitable for producing a plasma display panel member, and a method for producing the paste.

2. Description of the Related Art

A plasma display panel (abbreviated to “PDP” hereinafter) attracts attention as a display, which can be used for a thin and large-screen television. The PDP mainly comprises a front panel and a rear panel.

Also, plural pairs of sustaining electrodes each composed of a material such as silver, chromium, aluminum, nickel or the like are formed on a glass substrate of the front plate serving as a display surface. A dielectric layer mainly composed of glass is formed to a thickness of 20 to 50 μm to cover the sustaining electrodes. Furthermore, a MgO layer is formed to cover the dielectric layer.

On the other hand, a plurality of address electrodes is formed in stripes on a glass substrate of the rear plate. A dielectric layer mainly composed of glass is formed to cover the address electrodes. Furthermore, barrier ribs are formed on the dielectric layer to form divided discharge cells, and a phosphor layer is formed in each of the discharge spaces formed by the barrier ribs and the dielectric layer. In the PDP capable of a full-color display, the phosphor layer comprises phosphors respectively emitting lights of red, green and blue.

The front plate and the rear plate are sealed so that the sustaining electrodes on the glass substrate of the front plate intersect at right angles the address electrodes of the rear plate, and a rare gas composed of helium, neon, xenon, or the like is sealed in the gap between both substrates to form the PDP. Since a display cell is formed with each of the intersections of the scan electrodes and the address electrodes as a center, the PDP has a plurality of display cells to permit an image display.

In order to form the electrodes, the dielectric layer, the barrier ribs and the phosphor layer, a paste containing a binder resin and an inorganic powder such as a metal powder, a glass powder, a phosphor power, or the like, which is dispersed in the binder resin, is generally used. As a means for dispersing the inorganic powder in the binder resin, a roll mill comprising three rollers is conventionally used in many cases.

However, the three rollers are used in an open batch-system apparatus and thus have various problems with quality, production cost, a working environment, etc. A first problem is that the working environment is worsened by evaporation of a solvent from the paste, a second problem is that the number of steps is increased by a step of recontrolling viscosity because the viscosity is changed, a third problem is contamination with foreign substances from the surrounding work environment, and a fourth problem is a difficult in connecting steps before and after the three rollers, for permitting a continuous treatment. A fifth problem is that the diameter and length of a roll must be increased for increasing a throughput, thereby making the apparatus heavier and making the roll gap nonuniform to cause a defect in dispersion of the paste.

As an alternative to the open batch-system three rollers, a sand mill is disclosed in Japanese Unexamined Utility Model Publication No. 7-7740 (pages 1 to 4). Although the sand mill may have a closed structure and is capable of a continuous treatment, the application of the sand mill to dispersion of a paste for producing a PDP has a difficulty in controlling a grinding condition and thus has a difficulty in applying to the production of the paste for producing a PDP. More specifically, for example, the particle diameter of the phosphor powder changes to cause to deteriorate brightness, or the particle diameter distribution of the metal powder or glass powder changes to cause the problem of changing the photosensitive characteristics of a photosensitive paste. Also, the paste for producing a PDP contains a large amount of inorganic powder and thus has a viscosity of several tens of thousands mPa·s, and thus a medium is concentrated in a screen and gap separator disposed at the outlet of the sand mill, thereby causing the problem of interfering with the operation.

Also, Japanese Unexamined Patent Application Publication No. 11-197479 discloses a roller mill as a dispersing device which may have a closed structure and which is capable of a continuous treatment. However, the use of the roller mills for dispersing the paste for producing a PDP has the problem that the internal pressure of a vessel is increased to interfere with the operation.

### SUMMARY OF THE INVENTION

In consideration of the problems of the conventional techniques, an object of the present invention is to provide a high-quality low-cost paste including an inorganic powder.

Another object of the present invention is to provide a method for producing a high-quality low-cost plasma display panel member by using the paste including the inorganic powder.

In order to achieve the objects, the present invention has the following construction.

(1) A method for producing a paste including an inorganic powder comprises dispersing a paste including an inorganic powder by a disperser that comprises rollers provided in a cylindrical vessel.

(2) In the method (1) for producing the paste including the inorganic powder, the disperser comprises a paste supply port provided at one end of the cylindrical vessel, and a paste discharge port provided at the other end of the cylindrical vessel.

(3) In the method (2) for producing the paste including the inorganic power, the paste including the inorganic powder is supplied to the paste supply port by using a metering pump.

(4) In the method (1) for producing the paste including the inorganic powder, the disperser comprises a rotatable rotor disposed in the cylindrical vessel and having a plurality of grooves parallel to the rotational axis, and the rollers are provided in the respective grooves to revolve in contact with the inner wall of the cylindrical vessel while rotating on their own axes so that when the rotor rotates, a gap is formed between at least the inner wall of each groove and the roller by a centrifugal force.

(5) In the method (1) for producing the paste including the inorganic powder, each of the rollers has a diameter in the range of 5 to 50 mm, and a length in the range of 10 to 100 mm.

(6) In the method (1) for producing the paste including the inorganic powder, each of the inner wall of the cylindrical vessel and the rollers of the disperser is made of a ceramic material.

(7) In the method (1) for producing the paste including the inorganic powder, the viscosity of the paste including the inorganic powder is 10,000 to 80,000 mPa·s.

(8) In the method (1) for producing the paste including the inorganic powder, the content of the inorganic powder in the paste including the inorganic powder is in the range of 30 to 95% by weight.

(9) In the method (1) for producing the paste including the inorganic powder, the inorganic powder comprises at least one selected from glass, a fireproof filler, a phosphor, a metal and a metal oxide.

(10) In the method (1) for producing the paste including the inorganic powder, the paste including the inorganic powder comprises a compound having an unsaturated double bond.

(11) A paste including an inorganic powder produced by any one of the methods (1) to (10) of producing the paste including the inorganic powder.

(12) The paste (11) including the inorganic powder is used for forming an electrode, a black stripe, a dielectric material, a barrier rib, and a phosphor of a display.

(13) In the paste (11) including the inorganic powder, the content of foreign substances is 15 mg or less.

(14) A method for producing a plasma display panel member comprises the step of coating a paste including an inorganic powder at least on a substrate, wherein the paste including the inorganic powder is the paste (11) including the inorganic powder.

### BRIEF DESCRIPTION OF THE DRAWINGS

FIG. 1 is a side view schematically showing a disperser used in the present invention;

FIG. 2 is a cross-sectional view showing a most preferred example of a roller portion of a disperser used in the present invention;

FIG. 3 is an enlarged view of the roller portion shown in FIG. 2;

FIG. 4 is a cross-sectional view showing another example of the roller part of the disperser; and

FIG. 5 is a cross-sectional view showing a case in which a taper roller bearing is used for a roller portion of a disperser.

### DESCRIPTION OF THE PREFERRED EMBODIMENTS

The present invention will be described in further detail below.

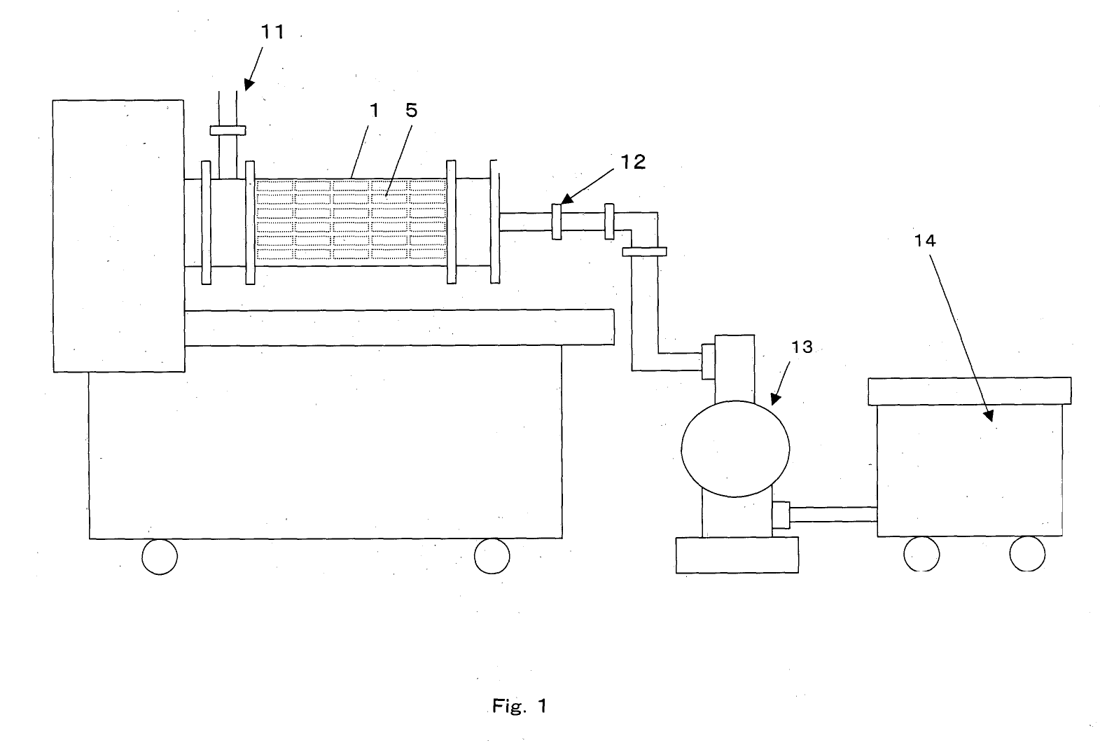

As shown in FIG. 1, an example of a disperser used for dispersing a paste including an inorganic power of the present invention comprises rollers 5 provided in a cylindrical vessel 1. The apparatus shown in FIG. 1 comprises a paste supply port 12 provided at one end of the cylindrical vessel 1, and a paste discharge port 11 provided at the other end, thereby permitting a continuous treatment. The paste including the inorganic powder is mainly composed of an inorganic powder and a binder resin.

In a preferred method for the continuous treatment, the paste is supplied to the paste supply port 12 by a metering pump 13. Examples of the metering pump 13 include a centrifugal pump, a propeller pump, a viscosity pump, a reciprocating pump, a rotary pump, and the like. Examples of the centrifugal pump include a single-stage volute pump, a multi-stage volute pump, a single-stage turbine pump, a multi-stage turbine pump, and the like. Examples of the propeller pump include an axial-flow pump, a mixed flow volute pump, and the like. Examples of the viscosity pump include a single-stage volute pump, a multi-stage volute pump, and the like. Examples of the reciprocating pump include a horizontal piston pump, a vertical piston pump, a horizontal plunger pump, a vertical plunger pump., a diaphragm pump, a tube pump, a wing pump, and the like. Examples of the rotary pump include an external gear pump, an internal gear pump, an eccentric screw pump, a vane pump, a roller pump, and the like.

Particularly, the diaphragm pump and the eccentric screw pump are preferred for supplying the high-viscosity paste used in the present invention. By using the metering pump 13, the paste having stable dispersibility can be obtained. Also, a wetted part of the disperser is preferably made of or coated with a ceramic material such as zirconia, sialon, or the like because abrasion resistance can be improved. Also, before the paste is supplied to the disperser by the metering pump 13, it is preferable to disperse the paste by the preliminary dispersion machine 14.

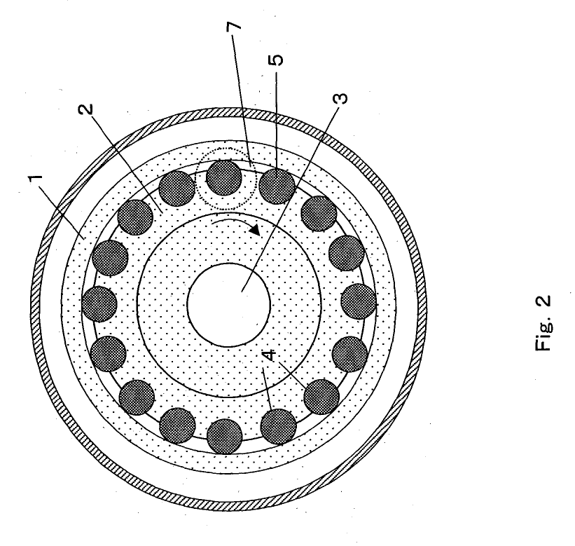

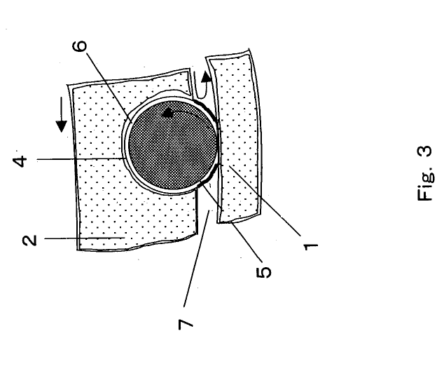

Furthermore, the disperser of the present invention preferably has the structure shown in FIGS. 2 and 3. As shown in FIG. 2, a rotatable rotor 2 is disposed coaxially with the cylindrical vessel 1, and the rotor 2 has a plurality of grooves 4 formed in its periphery in parallel to the rotational axis 3 so that when the rotor 2 rotates, a small gap 6 is formed between at least the inner wall of each groove 4 and the roller 5 provided therein by a centrifugal force. Also, the rollers 5 are provided in the respective grooves 4 to revolve in contact with the inner wall of the cylindrical vessel 1 while rotating on their own axes, and thus the whole of the paste including the inorganic powder can be uniformly dispersed without the pass (short pass) of the untreated paste.

Each of the rollers provided in the cylindrical vessel 1 preferably has a diameter in the range of 5 to 50 mm, and a length in the range of 10 to 100 mm. More preferably, the diameter is in the range of 6 to 30 mm, and the length is in the range of 15 to 80 mm. With the rollers each having the dimensions in these ranges, the paste having excellent dispersibility can be obtained.

In the disperser, when the rotor 2 rotates in the cylindrical vessel 1, the roller 5 provided in each groove 4 of the rotor 2 revolves in contact with at least the inner wall of the cylindrical vessel 1 by the centrifugal force while rotating on its own axis. The paste supplied into the cylindrical vessel 1 through the supply port is pressed on the inner wall of the cylindrical vessel 1 by the rollers 5 and pushed to the discharge port. Since the roller 5 is inserted into each of the grooves 4 of the rotor 2, the rotation number of the rotor 2 is equal to the revolution speed of each roller 5. Therefore, when the rotor 2 rotates, the paste is strongly pressed on the inner wall of the cylindrical vessel 1 by the centrifugal force and is repeatedly subjected to a compressing and shearing function.

In this case, a passing area of the paste is limited to the vicinity of the inner wall of the cylindrical vessel 1. In other words, as shown in FIG. 3, the passing area of the paste is the gap 7 formed between the inner wall of the cylindrical vessel 1 and the outer periphery of the rotor 2. In this specified area, a flow of the paste constantly occurs by an agitating function of the rotor 2 as shown by an arrow in FIG. 3. As a result, the paste is constantly circulated in the specified are and uniformly dispersed.

Furthermore, the disperser used in the present invention will be described below with reference to FIG. 3. When the rotor 2 rotates, the gap 6 is formed between the inner wall of each groove 4 and the outer periphery of the roller 5 by a centrifugal force, and the paste also enters into the gaps 6 and is subjected to the strong shearing function of the rollers 5 rotating in the grooves 4.

The plurality of the grooves 4 is preferably radially formed from the viewpoint of improvement in dispersibility. Since the plurality of the grooves 4 is radially formed, the paste is uniformly subjected to the compressing and shearing function of the rollers 5 provided in the grooves 4. Furthermore, a plurality of the rollers 5 is preferably tightly provided in each groove 4 in parallel to the rotational axis. When a plurality of the rollers 5 is tightly provided in each groove 4 in parallel to the rotational axis, the whole inner wall of the cylindrical vessel 1 can be used as a dispersion area. Therefore, each of the rollers 5 provided in each groove 4 independently has the compressing and shearing function to produce the paste having improved dispersibility.

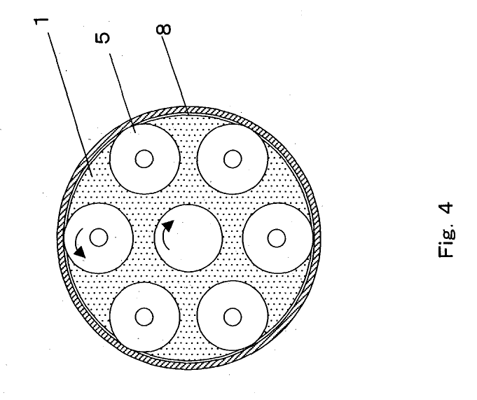

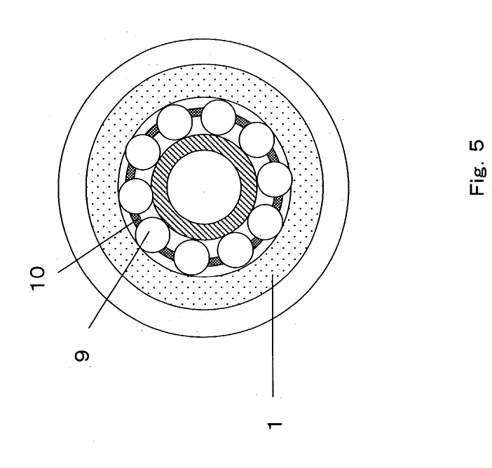

Besides the disperser shown in the drawings, any disperser may be used as long as rollers are provided in a cylindrical vessel. For example, as shown in FIG. 4, each of rollers 5 revolves in the cylindrical vessel 1 while rotating on its axis to apply the compressing and shearing function to the paste between the rollers 5 and the inner wall 8 of the vessel 1. Also, as shown in FIG. 5, a plurality of taper roller bearings 10 is disposed in a cylindrical vessel so that the paste is dispersed by a pressure produced when the bearing rollers 9 rolls on a rolling contact surface.

In each of these dispersers, at least the inner wall of the cylindrical vessel and/the rollers are made of a ceramic material such as zirconia, sialon, or the like because the abrasion resistance can be improved.

The disperser used in the present invention may be the horizontal type shown in FIG. 1 in which the paste supply port 12 is provided at one end of the cylindrical vessel 1, and the paste discharge port 11 is provided at the other end, or a vertical type in which the paste supply port 12 is provided at the lower end, and the paste discharge port 11 is provided at the upper end. In the vertical type, the bubbles produced in the paste including the inorganic powder can be decreased to shorten the time of a degassing step after a dispersion step.

In the present invention, the paste including the inorganic powder is mainly composed of an inorganic powder and a binder resin. The content of the inorganic powder is preferably 30 to 95% by weight, and more preferably 32 to 90% by weight, because of a low degree of shrinkage and a small change in shape by burning in the PDP producing process are low. Examples of the inorganic powder in the paste include a glass powder, a phosphor powder, a metal powder, and the like.

The glass powder preferably has a thermal expansion coefficient at 50 to 400° C. of 50×10⁻⁷ to 100×10⁻⁷. The electrical, mechanical and thermal characteristics required for barrier ribs, such as electrical insulation, strength, a thermal expansion coefficient, the compactness of an insulating layer, etc., can be improved by mixing 3 to 60% by weight of silicon oxide and 5 to 50% by weight of boron oxide with glass. The glass powder used in the present invention preferably mainly comprises a low-melting-point glass powder. The glass transition temperature of the low-melting-point glass powder is preferably 430 to 500° C., and the glass softening point is preferably 470 to 620° C. With the glass transition temperature and the glass softening point within these ranges, the substrate is less distorted by burning, and a compact barrier rib layer can be obtained. Although the particle diameter of the glass powder is selected in consideration of the line width and height of the barrier ribs to be formed, preferably, the central diameter of a volume-based diameter distribution is 1 to 6 μm, the maximum particle size is 30 μm or less, and the specific surface area is 1.5 to 4 cm²/g.

Examples of the phosphor powder of red include Y₂O₃:Eu, YVO₄:Eu, (Y,Gd)BO₃:Eu, Y₂O₃S:Eu, γ-Zn₃(PO₄)₂:Mn, (ZnCd)S:Ag+In₂O₃, and the like. Examples of the phosphor powder of green include Zn₂GeO₃:Mn, BaAl₁₂O₁₉:Mn, Zn₂SiO₄:Mn, LaPO₄:Tb, ZnS:Cu,Al, ZnS:Au,Cu,Al, (ZnCd)S:Cu,Al, Zn₂SiO₄:Mn,As, Y₃Al₅O₁₂:Ce, CeMgAl₁₁O₁₉:Tb, Gd₂O₂S:Tb, Y₃Al₅O₁₂:Tb, ZnO:Zn, and the like. Examples of the phosphor powder of blue include Sr₅(PO₄)₃Cl:Eu, BaMgAl₁₄O₂₃:Eu, BaMgAl₁₆O₂₇: Eu, BaMg₂Al₁₄O₂₄:Eu, ZnS:Ag+red pigment, Y₂SiO₃:Ce, and the like.

Also, a rare earth tantalate phosphor comprising at least one rare earth element which is selected as a mother component from yttrium (Y), gadolinium (Gd), and lutetium (Lu) and which is substituted by at least one element selected from thulium (Tm), terbium (Tb) and europium (Eu) can be used. The rare earth tantalate phosphor is preferably a europium-activated yttrium tantalate phosphor represented by the composition formula Y₁₋ₓEuₓTaO₄ (wherein x is about 0.005 to 0.1). The europium-activated yttrium tantalate phosphor is preferably used as a red phosphor, and a terbium-activated yttrium tantalate phosphor represented by the composition formula Y₁₋ₓTbₓTaO₄ (wherein x is about 0.001 to 0.2) is preferably used-as the rare earth tantalate phosphor of green. A thulium-activated yttrium tantalate phosphor represented by the composition formula Y₁₋ₓTmₓTaO₄ (wherein x is about 0.001 to 0.2) is preferably used as the rare earth tantalate phosphor of blue.

The phosphor powder used for the phosphor paste of the present invention preferably has an area-mean diameter (Ds) of 1.0 to 2.5 μm, a volume-based diameter distribution having a central diameter (Dv) of 1.8 to 4.5 μm, and a ratio (Ds/Dv) of 1.2 to 2.5. More preferably, Ds is in the range of 1.2 to 2.3 μm, Dv is in the range of 2.0 to 4.2 μm, and Ds/Dv is in the range of 1.3 to 2.3. With Ds, Dv and Ds/Dv in these ranges, the filterability of the paste can be improved.

As the metal powder, a powder containing at least one element selected from the group consisting of Ag, Au, Pd, Ni, Cu, Al and Pt may be used. These metals may be used singly or in an alloy or a powder mixture. The metal powder preferably has a volume-based diameter distribution having a central diameter of 0.7 to 6 am, and more preferably 1.3 to 4 μm. With a particle diameter within this range, an accurate fine pattern can be formed.

The binder resin in the paste of the present invention preferably does not leave a carbide in an inorganic material by oxidation or/and decomposition or/and evaporation in burning. Preferred examples of the binder resin include cellulose resins such as ethyl cellulose, methyl cellulose, nitro cellulose, cellulose acetate, cellulose propionate, cellulose butylate, and the like; acryl resins comprising a polymer or copolymer such as methyl (metha)acrylate, ethyl (metha)acrylate, normal butyl (metha)acrylate, isobutyl (metha)acrylate, isopropyl (metha)acrylate, 2-ethylmethyl (metha)acrylate, 2-hydroxyethyl (metha)acrylate, and the like; poly-α-methylsulfone, polyvinyl alcohol, polybutene, and the like. The content of the binder resin of the paste of the present invention is preferably 5 to 65% by weight, and more preferably 10 to 60% by weight.

Examples of other components of the paste of the present invention include additives such as an organic solvent, a plasticizer, an antioxidant, a defoaming agent, a dispersant, a leveling agent, and the like; a fireproof filler; and the like. Particularly, when the paste of the present invention is used as photosensitive paste, a photosensitive component such as a photosensitive polymer, a photosensitive oligomer, a photosensitive monomer, or the like, and additives such as a photopolymerization initiator, a sensitizer, an ultraviolet absorber, a polymerization inhibitor, and the like may be added.

In order to control the viscosity of the paste for coating on the substrate according to the coating method, the organic solvent is used. Examples of the organic solvent used for this purpose include diethylene glycol monobutyl ether acetate, ethylene glycol monobutyl ether acetate, ethylene glycol mono-2-ethyl hexyl ether, diethylene glycol mono-2-ethyl hexyl ether, 2,2,4-trimethyl-1,3-pentanediol monoisobutylate, 2,2,4-trimethyl-1,3-pentanediol diisobutylate, 2-ethyl-1,3-hexanediol, terpineol, benzyl alcohol, 1-butoxy-2-propane, 1,2-diacetoxypropane, 1-methoxy-2-propanol, 2-acetoxy-1-ethoxypropane, (1,2-methoxypropoxy)-2-propanol, (1,2-ethoxypropoxy)-2-propanol, 2-hydroxy-4-methyl-2-pentanone, 3-methoxy-3-methylbutyl acetate, 2-methoxyethanol, 2-ethoxyethanol, 2-(methoxymethoxy)ethanol, 2-isopropoxyethanol, 2-butoxyethanol, 2-(isopentyloxy)ethanol, 2-(hexyloxy)ethanol, 2-phenoxyethanol, 2-(benzyloxy)ethanol, benzyl alcohol, furfuryl alcohol, tetrafurfuryl alcohol, 2,2′-dihydroxydiethyl ether, 2-(2-methoxyethoxy)ethanol, 2-[2-(2-methoxyethoxy)ethoxy]ethanol, 2-methyl-1-butanol, 3-methyl-2-butanol, 2-methyl-1-pentanol, 4-methyl-2-pentanol, 2-ethyl-1-butanol, 2-methoxyethyl acetate, 2-ethoxyethyl acetate, 2-butoxyethyl acetate, 2-phenoxyethyl acetate, 1,2 -dimethoxyethane, 1,2-diethoxyethane, 1,2-dibutoxyethane, cyclohexanone, methyl acetate, ethyl acetate, propyl acetate, isopropyl acetate, butyl acetate, 1-methylpentyl acetate, 2-ethylbutyl acetate, 2-ethylhexyl acetate, cyclohexyl acetate, benzyl acetate, hexane, cyclohexane, methyl ethyl ketone, 2-pentanone, 3-pentanone, 2-hexanone, methyl isobutyl ketone, 2-heptanone, 4-heptanone, diisobutyl ketone, and the like. The organic solvent is preferably a good solvent for the binder resin used. Furthermore, the solvent is mainly selected in consideration of volatility of the solvent and solubility of the binder resin used. This is because when the binder resin has low solubility in the solvent, a coating solution has high viscosity even with a same solid content and is thus liable to deteriorate in a coating property.

With respect to content of the organic solvent, an excessively small amount of the organic solvent excessively increases the viscosity of the phosphor paste to cause a difficulty in removing bubbles from a material for forming the barrier ribs, and thus a coating surface is likely to have low smoothness due to defective leveling. On the other hand, with an excessively large amount of the organic solvent, dispersed particles rapidly deposit to cause a difficulty in stabilizing the composition of the phosphor paste and cause the problem of requiring much energy and time for drying. Therefore, the content of the solvent in the paste is preferably 35 to 65% by weight, and more preferably 40 to 60% by weight.

The fireproof filler is preferably added for stabilizing the shape during burning. As the fireproof filler, filler that does not soften at a burning temperature of about 500 to 650° C. can be widely used. Examples of such fireproof filler include high-melting-point glass or ceramic powders of alumina, magnesia, calcia, cordierite, silica, mullite, zircon, zirconia, and the like. When the color of the barrier ribs is darkened for decreasing the reflection of outside light from the PDP and increasing a practical contrast, a pigment of Co—Cr—Fe, Co—Mn—Fe, Co—Fe—Mn—Al, Co—Ni—Cr—Fe, Co—Ni—Mn—Cr—Fe, Co—Ni—Al—Cr—Fe, Co—Mn—Al—Cr—Fe—Si, or the like may be used as a fireproof black pigment. On the other hand, when the color of the barrier ribs is made white for effectively guiding light emitted from the phosphor to the front of the panel, titania or the like may be used as a fireproof white pigment.

As the photosensitive monomer, a compound having an active carbon-carbon unsaturated double bond is frequently used. A mono- or poly-functional compound having a functional group such as a vinyl group, an allyl group, an acrylate group, a methacrylate group, an acrylamide group or the like can be used. Examples of such a compound include 2-(2-ethoxyethoxy)ethyl acrylate, 1,3-butandiol diacrylate, pentaerythritol triacrylate, ditrimethylolpropane tetraacrylate, cyclohexyl methacrylate, ethylene glycol dimethacrylate, trimethylolpropane trimethacrylate, glycidyl methacrylate, and the like.

When the paste of the present invention is used as a photosensitive paste, the photosensitive polymer and/or the photosensitive oligomer is preferably used as the binder resin. The oligomer or polymer is obtained by polymerizing or co-polymerizing a component selected from compounds each having a carbon-carbon unsaturated double bond.

Copolymerization with an unsaturated acid such as an unsaturated carboxylic acid or the like can improve a development property with an alkali aqueous solution after sensitization. Examples of the unsaturated carboxylic acid include acrylic acid, methacrylic acid, itaconic acid, crotonic acid, maleic acid, fumaric acid, vinylacetic acid and anhydrides thereof, and the like.

The resultant polymer or oligomer having acid groups such as carboxyl groups at its side chains preferably has an acid value in the range of 50 to 180, and more preferably in the range of 70 to 140. From the viewpoint of a photosensitive property, the photopolymerization initiator is preferably added in an amount of 0.005 to 5% by weight based on the amount of the photosensitive paste.

The paste of the present invention is uniformly formed by preparing the components for a predetermined composition, preliminarily dispersing the components by a mixer such as a planetary mixer or the like, and then dispersing and kneading the resultant mixture by the disperser comprising the rollers provided in the cylindrical vessel.

The paste including the inorganic powder prepared as described above contains 15 mg or less of foreign substances, which is significantly smaller than that in a conventional method.

From the viewpoint of dispersibility and coatability, the viscosity of the paste including the inorganic powder to be dispersed is preferably in the range of 10,000 to 80,000 mPa·s, and more preferably in the range of 15,000 to 65,000 mPa·s.

A description will now be made of an example in which the paste produced by the paste producing method of the present invention is applied to a display panel member.

First, stripe electrodes are formed as address electrodes on a substrate by a photolithography process using a photosensitive silver paste, and a dielectric paste is then coated on the substrate by a screen printing process and then burned at 500 to 600° C. to form a dielectric layer.

Furthermore, a pattern is formed on the dielectric layer by a photolithography process using a photosensitive glass paste, and then burned at 500 to 600° C. for 10 to 60 minutes to form a stripe-shaped barrier rib pattern.

Furthermore, the phosphor paste is coated on the barrier ribs formed as described above. The method for coating the phosphor paste is not limited, and any one of a screen printing process, a method for discharging the phosphor paste from a nozzle, a photosensitive paste method, and the like may be used. Particularly, the method for discharging the phosphor paste from the nozzle and the screen printing process are preferred because they are simple and capable of producing a low-cost PDP. After the phosphor-paste is coated and then dried, the coating is burned, for example, at 500° C. for 30 minutes to form a phosphor layer on the sides and bottoms of the barrier ribs.

### EXAMPLES

Although the present invention will be described in detail below with reference to examples, the present invention is not limited to these examples. In each of the examples, a concentration (%) is % by weight.

(Paste Composition)

(1) Barrier Rib Paste

A photosensitive paste comprising 52% of a glass powder having a mean particle diameter of 2 μm and prepared by grinding glass composed of lead oxide, boron oxide, zinc oxide, silicon oxide and barium oxide as main components, 12% of a methyl methacrylate/methacrylic acid copolymer (composition ratio by weight: 60/40, a weight average molecular weight of 32000), 12% of dipentaerythritol hexaacrylate, 1.94% of benzophenone, 0.05% of 1,6-hexanediol-bis [(3,5-di-t-butyl-4-hydroxyphenyl)propionate], 0.01% of an organic dye (Basic blue 7) and 22% of an organic solvent (propylene glycol monomethyl ether acetate)

(2) Red Phosphor Paste

35% of a phosphor powder of (Y, Gd, Eu)BO₃ having a mean particle diameter of 3 μm, 7% of ethyl cellulose, and 58% of an organic solvent (terpineol.)

(3) Green Phosphor Paste

33.5% of a phosphor powder of (Zn, Mn)₂SiO₂ having a mean particle diameter of 2.5 μm, 6.5% of ethyl cellulose, and 60% of an organic solvent (terpineol)

(4) Blue Phosphor Paste 1

33.5% of a phosphor powder of (Ba, Eu)MgAl₁₀O₁₇ having a mean particle diameter of 2 μm, 6.5% of ethyl cellulose, and 60% of an organic solvent (terpineol)

(5) Blue Phosphor Paste 2

25.5% of a phosphor powder of (Ba, Eu)MgAl₁₀O₁₇ having a mean particle diameter of 2 μm, 6.5% of ethyl cellulose, and 68% of an organic solvent (terpineol)

(6) Dielectric Paste

80% of borosilicate glass having a softening point of 410° C. and a mean particle diameter of 5 μm, 2% of ethyl cellulose and 18% of an organic solvent (terpineol)

(7) Electrode Paste

A photosensitive paste comprising 3% of a glass powder having a mean particle diameter of 0.8 μm and prepared by grinding glass composed of bismuth oxide, silicon oxide, boron oxide, zirconium oxide, zinc oxide and aluminum oxide, 6% of a methyl methacrylate/methacrylic acid copolymer (composition ratio by weight: 60/40, a weight average molecular weight of 32000), 3% of dipentaerythritol hexaacrylate, 1% of benzophenone, 74% of an Ag powder having a mean particle diameter of 1.2 μm, and 13% of an organic solvent (propylene glycol monomethyl ether acetate)

(8) Dielectric Paste for the Front Plate

75% of PbO·B₂O₃·SiO₂ glass having a softening point of 475° C. and a mean particle diameter of 3.8 μm, 3% of ethyl cellulose, and 22% of an organic solvent (propylene glycol n-propyl ether/tripropylene glycol n-butyl ether=80/20)

(9) Black Paste

A photosensitive black paste comprising 28% of a Cu—Fe—Mn black pigment having a mean particle diameter of 0.25 μm, 35% of a glass powder having a mean particle diameter of 1.0 μm and prepared by grinding glass composed of bismuth oxide, silicon oxide, zirconium oxide, zinc oxide and aluminum oxide, 12% of a methyl methacrylate/methacrylic acid copolymer (composition ratio by weight: 60/40, a weight average molecular weight of 32000), 5% of dipentaerythritol hexaacrylate, 1% of benzophenone, and 19% of an organic solvent (dipropylene glycol methyl ether)

(Method for Evaluating a Paste)

(1) Viscosity

Measured with a field-type viscometer (produced by Brookfield Co., Ltd., Model DV-1) at a rotation number of 3 rpm at a measurement temperature of 25° C.

(2) Dispersibility

A distribution density is observed by reading the scale of a lump of grains with a grind gauge (produced by Erichsen Co., Ltd., 0 to 50 μm However, when a boundary line of the lump of grains appears between the scales, or when two grooves of the gauge show different values, the scale of a larger value is read, and a central value of three measurements is considered as the degree of dispersion of a paste.

(3) A Total Amount of Foreign Substances

20 kg of a paste after dispersion is filtered with a disk filter of 293 mm in diameter (filtration pressure: 0.2 Mpa, filter: 500 mesh), and then the filter is placed in a clean vessel and immersed in clean acetone and washed in an ultrasonic cleaning machine for 30 minutes. After washing, the washing solution is further filtered with a disk filter of 25 mm in diameter (filtration pressure: 0.05 MPa, filter: nylon net [pore size 11 μm]). Then, the total amount of the foreign substances remaining on the filter is measured by a precision balance.

### Examples 1 to 5

A predetermined amount of each paste was weighed and preliminarily dispersed by a planetary mixer (produced by Inoue Seisakusho). The dispersion was performed at 30 rpm for 60 minutes. After preliminary dispersion, an upper kettle was set on a lower kettle of the mixer, and the mixer was connected, through a Teflon (registered trademark) tube of 18 mm in diameter, to a disperser comprising rollers provided in a cylindrical vessel. An air pressure of 0.2 MPa was applied to the mixer kettle to push out the paste in the mixer kettle to the cylindrical vessel of the disperser. The disperser was operated at 300 rpm. Then, the paste completely dispersed was filtered with a disk filter of 293 mm in diameter (filtration pressure: 0.2 MPa, filter: 500 mesh).

The throughput of each paste was 20 kg. Tables 1 and 2 show the results of measurement of the time required for dispersing 20 kg of each paste, the degree of dispersion after dispersion treatment, viscosity, and the total amount of foreign substances remaining on the disk filter.

Next, a rear plate of an AC (alternating current) plasma display panel was formed by using a glass substrate (produced by Asahi Glass-Co., Ltd., “PD-200”) of a size of 340×260×2.8 mm.

First, stripe electrodes each having a line width 60 μm and a thickness of 4 μm after burning were formed as address electrodes with a pitch of 140 μm on the substrate by a photolithography process using the photosensitive electrode paste. Then, the dielectric paste was coated on the substrate by a screen printing process and then burned at 550° C. to form a dielectric layer having a thickness of 10 μm.

Furthermore, a pattern was formed on the dielectric layer by a photolithography process using the barrier rib paste and then burned at 570° C. for 15 minutes to form a stripe-shaped barrier rib pattern having a pitch of 140 μm, a line width of 20 μm and a height of 100 of μm.

Then, the phosphor paste was coated on the thus-formed barrier ribs by a method for discharging the phosphor paste from a nozzle to form a phosphor layer on the sides and bottoms of the barrier ribs.

Next, the steps below formed a front plate. First, ITO was coated on the same glass substrate as that of the rear plate by a sputtering process, and a resist was coated on the ITO, followed by exposure, development and etching to form transparent electrodes each having a thickness of 0.1 μm and a line width of 200 μm. Also, bus electrodes each having a thickness of 10 μm after burning was formed by a photolithography process using the photosensitive electrode pate composed of a black silver powder. The electrodes were formed with a pitch of 140 μm and a line width of 60 μm.

Furthermore, the transparent dielectric paste was coated to a thickness of 20 μm on the front plate having the electrodes formed thereon, and burned by maintaining at 430° C. for 20 minutes. Next, a MgO film was formed to a thickness of 0.5 μm by an electron beam evaporation machine to uniformly cover the transparent electrodes, the black electrodes and the dielectric layer, completing the front plate.

The resultant front plate and the rear plate were bonded together and sealed, and a discharge gas was sealed between both plates. Then, driving circuits were connected to the plates to form the plasma display panel (PDP). A display state of the panel was observed by applying a voltage thereto. The observation results are shown in Tables 1 and 2.

### Example 6

A predetermined amount of each paste was weighed and preliminarily dispersed by a planetary mixer (produced by Inoue Seisakusho). The dispersion was performed at 30 rpm for 60 minutes. After the preliminary dispersion, the same process as in Examples 1 to 5 was performed except that a lower kettle of the mixer was set, and each paste was supplied to the disperser through a double-diaphragm pump (produced by Irie Seisakusho, YD model) at a pump discharge pressure of 0.05 MPa.

### Example 7

A paste including an inorganic powder was prepared by the same method as in Examples 1 to 5, and then a rear plate and front plate were formed for completing a PDP.

### Comparative Examples 1 to 3

A predetermined amount of each paste was weighed and preliminarily dispersed by a planetary mixer (produced by Inoue Seisakusho). The dispersion was performed at 30 rpm for 60 minutes. After preliminary dispersion, the paste was divided into parts in 2-liter polyethylene vessels, and dispersed with three rollers (produced by Inoue Seisakusho). The dispersion was performed at a roller rotation number of 40 rpm. The pass numbers in Comparative Example 1, 2 and 3 were 1, 2 and 3, respectively. Then, the completely dispersed paste was filtered with a disk filter of 293 mm in diameter (filtration pressure: 0.2 MPa, filter: 500 mesh).

The throughput of each paste was 20 kg. Tables 1 and 2 show the results of measurement of the time required for dispersing 20 Kg of each paste, the degree of dispersion after dispersion treatment, viscosity, and the total amount of foreign substances remaining on the disk filter.

A display state of a panel was observed by the same method as that in Examples 1 to 5. The results are shown in Tables 1 and 2.

TABLE 1

| | | | | | | | | | Comp. | Comp. | Comp. |
|---|---|---|---|---|---|---|---|---|---|---|---|
| | | Example 1 | Example 2 | Example 3 | Example 4 | Example 5 | Example 6 | Example 7 | Example 1 | Example 2 | Example 3 |
| Treatment condition | | 280 rpm | 420 rpm | 140 rpm | 280 rpm | 280 rpm | 280 rpm | 280 rpm | — | — | — |
| Roller diameter (mm) | | 10 | 10 | 10 | 10 | 4 | 10 | 10 | — | — | — |
| Roller length (mm) | | 30 | 30 | 30 | 120 | 30 | 30 | 30 | — | — | — |
| Number of passes | | 1 | 1 | 1 | 1 | 1 | 1 | 1 | 1 | 2 | 3 |
| Electrode | Viscosity | 24,500 | 23,500 | 25,000 | 26,000 | 24,500 | 24,500 | 24,500 | 28,000 | 30,500 | 35,000 |
| paste | (mPa · s) | | | | | | | | | | |
| | Dispersibility | 5 | 5 | 5 | 10 | 15 | 5 | 5 | 15 | 10 | 5 |
| | (μm) | | | | | | | | | | |
| | Amount of | 10 | 8 | 6 | 7 | 9 | 4 | 10 | 130 | 320 | 480 |
| | foreign | | | | | | | | | | |
| | substances | | | | | | | | | | |
| | (mg) | | | | | | | | | | |
| | Treatment time | 40 | 30 | 50 | 60 | 40 | 30 | 40 | 80 | 160 | 260 |
| | (min.) | | | | | | | | | | |
| Dielectric | Viscosity | 62,000 | 61,000 | 63,500 | 64,000 | 61,500 | 62,000 | 62,000 | 70,500 | 74,000 | 81,000 |
| paste | (mPa · s) | | | | | | | | | | |
| | Dispersibility | 5 | 5 | 5 | 10 | 15 | 5 | 5 | 20 | 15 | 10 |
| | (μm) | | | | | | | | | | |
| | Amount of | 8 | 6 | 8 | 8 | 10 | 4 | 8 | 140 | 360 | 520 |
| | foreign | | | | | | | | | | |
| | substances | | | | | | | | | | |
| | (mg) | | | | | | | | | | |
| | Treatment time | 60 | 45 | 65 | 80 | 60 | 50 | 60 | 90 | 180 | 300 |
| | (min.) | | | | | | | | | | |
| Red | Viscosity | 60,500 | 59,500 | 61,000 | 62,000 | 60,000 | 60,500 | 60,500 | 65,000 | 77,000 | 80,500 |
| phosphor | (mPa · s) | | | | | | | | | | |
| paste | Dispersibility | 5 | 5 | 5 | 10 | 15 | 5 | 5 | 20 | 15 | 10 |
| | (μm) | | | | | | | | | | |
| | Amount of | 9 | 10 | 11 | 7 | 6 | 4 | 9 | 130 | 320 | 430 |
| | foreign | | | | | | | | | | |
| | substances | | | | | | | | | | |
| | (mg) | | | | | | | | | | |
| | Treatment time | 60 | 45 | 65 | 80 | 60 | 50 | 60 | 90 | 180 | 300 |
| | (min.) | | | | | | | | | | |
| Green | Viscosity | 59,500 | 59,000 | 60,500 | 61,000 | 59,000 | 59,500 | 59,500 | 64,000 | 77,500 | 33,500 |
| phosphor | (mPa · s) | | | | | | | | | | |
| paste | Dispersibility | 5 | 5 | 5 | 10 | 15 | 5 | 5 | 20 | 15 | 10 |
| | (μm) | | | | | | | | | | |
| | Amount of | 10 | 8 | 10 | 9 | 8 | 5 | 10 | 140 | 300 | 460 |
| | foreign | | | | | | | | | | |
| | substances | | | | | | | | | | |
| | (mg) | | | | | | | | | | |
| | Treatment time | 60 | 45 | 65 | 60 | 40 | 50 | 60 | 70 | 140 | 240 |
| | (min.) | | | | | | | | | | |
| Blue | Viscosity | 52,500 | 52,000 | 53,500 | 54,500 | 52,000 | 52,500 | — | 57,500 | 62,500 | 65,000 |
| phosphor | (mPa · s) | | | | | | | | | | |
| paste 1 | Dispersibility | 5 | 5 | 5 | 10 | 15 | 5 | — | 20 | 15 | 10 |
| | (μm) | | | | | | | | | | |
| | Amount of | 8 | 7 | 6 | 7 | 10 | 6 | — | 120 | 280 | 410 |
| | foreign | | | | | | | | | | |
| | substances | | | | | | | | | | |
| | (mg) | | | | | | | | | | |
| | Treatment time | 50 | 40 | 60 | 50 | 40 | 40 | — | 60 | 120 | 200 |
| | (min.) | | | | | | | | | | |

| | | | | | | | | | | |
|---|---|---|---|---|---|---|---|---|---|---|
| Panel display | good | good | good | good | good | good | good | poor | poor | poor |
| characteristic | | | | | | | | | | |

TABLE 2

| | | | | | | | | | Comp. | Comp. | Comp. |
|---|---|---|---|---|---|---|---|---|---|---|---|
| | | Example 1 | Example 2 | Example 3 | Example 4 | Example 5 | Example 6 | Example 7 | Example 1 | Example 2 | Example 3 |
| Treatment condition | | 280 rpm | 420 rpm | 140 rpm | 280 rpm | 280 rpm | 280 rpm | 280 rpm | — | — | — |
| Roller diameter (mm) | | 10 | 10 | 10 | 10 | 4 | 10 | 10 | — | — | — |
| Roller length (mm) | | 30 | 30 | 30 | 120 | 30 | 30 | 30 | — | — | — |
| Number of passes | | 1 | 1 | 1 | 1 | 1 | 1 | 1 | 1 | 2 | 3 |
| Blue | Viscosity | — | — | — | — | — | — | 15,500 | 57,500 | 62,500 | 65,000 |
| phosphor | (mPa · s) | | | | | | | | | | |
| paste 2 | Dispersibility | — | — | — | — | — | — | 10 | 20 | 15 | 10 |
| | (μm) | | | | | | | | | | |
| | Amount of | — | — | — | — | — | — | 10 | 120 | 280 | 410 |
| | foreign | | | | | | | | | | |
| | substances | | | | | | | | | | |
| | (mg) | | | | | | | | | | |
| | Treatment time | — | — | — | — | — | — | 10 | 60 | 120 | 200 |
| | (min.) | | | | | | | | | | |
| Barrier | Viscosity | 42,500 | 41,000 | 43,000 | 43,500 | 41,000 | 42,500 | 42,500 | 45,500 | 47,000 | 50,000 |
| rib paste | (mPa · s) | | | | | | | | | | |
| | Dispersibility | 5 | 5 | 5 | 5 | 10 | 5 | 5 | 15 | 10 | 5 |
| | (μm) | | | | | | | | | | |
| | Amount of | 8 | 6 | 10 | 11 | 9 | 4 | 8 | 130 | 330 | 460 |
| | foreign | | | | | | | | | | |
| | substances | | | | | | | | | | |
| | (mg) | | | | | | | | | | |
| | Treatment time | 40 | 30 | 50 | 60 | 40 | 40 | 40 | 70 | 140 | 240 |
| | (min.) | | | | | | | | | | |
| Dielectric | Viscosity | 54,500 | 53,500 | 55,500 | 56,000 | 54,500 | 54,500 | 54,500 | 61,500 | 65,500 | 81,000 |
| paste for | (mPa · s) | | | | | | | | | | |
| front | Dispersibility | 5 | 5 | 5 | 10 | 15 | 5 | 5 | 20 | 15 | 10 |
| plate | (μm) | | | | | | | | | | |
| | Amount of | 8 | 6 | 8 | 8 | 8 | 4 | 8 | 150 | 420 | 670 |
| | foreign | | | | | | | | | | |
| | substances | | | | | | | | | | |
| | (mg) | | | | | | | | | | |
| | Treatment time | 60 | 45 | 60 | 75 | 60 | 55 | 60 | 90 | 180 | 300 |
| | (min.) | | | | | | | | | | |
| Black | Viscosity | 22,500 | 21,500 | 23,000 | 23,500 | 22,500 | 22,500 | 22,500 | 26,500 | 29,000 | 33,500 |
| paste | (mPa · s) | | | | | | | | | | |
| | Dispersibility | 5 | 5 | 5 | 10 | 5 | 5 | 5 | 15 | 10 | 10 |
| | (μm) | | | | | | | | | | |
| | Amount of | 10 | 8 | 8 | 9 | 10 | 6 | 10 | 180 | 340 | 510 |
| | foreign | | | | | | | | | | |
| | substances | | | | | | | | | | |
| | (mg) | | | | | | | | | | |
| | Treatment time | 40 | 30 | 50 | 60 | 40 | 35 | 40 | 80 | 160 | 260 |
| | (min.) | | | | | | | | | | |

| | | | | | | | | | | |
|---|---|---|---|---|---|---|---|---|---|---|
| Panel display | good | good | good | good | good | good | good | poor | poor | poor |
| characteristic | | | | | | | | | | |

The paste formed in each of Examples 1 to 3 contained small amounts of foreign substances, and thus the paste having high dispersibility was obtained within a short time. The panel formed by using each of these pastes exhibited good display characteristics. In Examples 4 and 5, the paste had slightly poor dispersibility. However, the paste contained small amounts of foreign substances, and the panel had good display characteristics.

The paste formed in Example 6 contained small amounts of foreign substances, and thus the paste having high dispersibility was obtained within a short time. The panel formed by using the paste exhibited good display characteristics.

In Example 7, the dispersion time was decreased because the paste containing a small amount of phosphor powder was used as a blue phosphor paste. However, irregularity occurred in a display due to the thin blue phosphor formed.

In Comparative Examples 1 to 3, each paste contained large amounts of foreign substances. Although the dispersibility was improved as the number of passes increased, the total amount of foreign substances and the paste viscosity increased. In order to improve the dispersibility, three passes were required to cause the need for a long treatment time. Also, the panel had poor display characteristics because the panel had many unlighted portions due to the foreign substances.

A paste having excellent dispersibility and containing small amounts of foreign substances, can be obtained by treatment using a disperser that comprises, rollers provided in a cylindrical vessel, within a short time. By using the paste, a high-quality and low-cost display panel member can be produced.

1. A method for producing a paste including an inorganic powder comprising dispersing a paste including an inorganic powder by a disperser which comprises a roller provided in a cylindrical vessel.

2. A method for producing a paste including an inorganic powder according to claim 1, wherein the disperser comprises a paste supply port disposed at one end of the cylindrical vessel, and a paste discharge port disposed at the other end of the cylindrical vessel.

3. A method for producing a paste including an inorganic power according to claim 2, wherein the paste including the inorganic powder is supplied to the paste supply port by a metering pump.

4. A method for producing a paste including an inorganic powder according to claim 1, wherein the disperser comprises a rotatable rotor disposed in the cylindrical vessel and having a plurality of grooves parallel to the rotational axis, and the rollers are provided in the respective grooves to revolve in contact with the inner wall of the cylindrical vessel while rotating on their own axes so that when the rotor rotates, a gap is formed between at least the inner wall of each groove and the roller by a centrifugal force.

5. A method for producing a paste including an inorganic powder according to claim 1, wherein each of the rollers has a diameter in the range of 5 to 50 mm, and a length in the range of 10 to 100 mm.

6. A method for producing a paste including an inorganic powder according to claim 1, wherein each of the inner wall of the cylindrical vessel and the rollers of the disperser is made of a ceramic material.

7. A method for producing a paste including an inorganic powder according to claim 1, wherein the viscosity of the paste including the inorganic powder is 10,000 to 80,000 mPa·s.

8. A method for producing a paste including an inorganic powder according to claim 1, wherein the content of the inorganic powder in the paste including the inorganic powder is in the range of 30 to 95% by weight.

9. A method for producing a paste including an inorganic powder according to claim 1, wherein the inorganic powder comprises at least one selected from a glass, a fireproof filler, a phosphor, a metal and a metal oxide.

10. A method for producing a paste including an inorganic powder according to claim 1, wherein the paste including the inorganic powder comprises a compound having an unsaturated double bond.

11. A paste including an inorganic powder produced by a method for producing a paste including an inorganic powder according to any one of claims 1 to 10.

12. A paste including an inorganic powder according to claim 11, wherein the paste is used for forming an electrode, a black stripe, a dielectric material, a barrier rib, and a phosphor of a display.

13. A paste including an inorganic powder according to claim 11, wherein the content of a foreign substance is 15 mg or less.

14. A method for producing a plasma display panel member comprising the step of coating a paste including an inorganic powder at least on a substrate, wherein the paste including the inorganic powder is a paste including an inorganic powder according to claim 11.
